(19) United States
(12) Patent Application Publication
(10) Pub. No.: US 2022/0114502 A1
(43) Pub. Date: Apr. 14, 2022

(54) INFORMATION PROCESSING APPARATUS, INFORMATION PROCESSING METHOD, AND RECORDING MEDIUM RECORDED WITH PROGRAM

(71) Applicant: TOYOTA JIDOSHA KABUSHIKI KAISHA, Toyota-shi (JP)

(72) Inventors: Takaharu UENO, Nagoya-shi (JP); Kenichi YAMADA, Nisshin-shi (JP); Ryosuke KOBAYASHI, Nagakute-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 17/481,407

(22) Filed: Sep. 22, 2021

(30) Foreign Application Priority Data
Oct. 8, 2020 (JP) 2020-170241

(51) Int. Cl. G06Q 10/02; G08G 1/00; G06Q 50/12

(52) U.S. Cl. CPC G06Q 10/02; G06Q 50/12; G08G 1/202

(57) ABSTRACT

An information processing apparatus includes a processor configured to: acquire information about behavior of a user visiting a restaurant; determine, based on the information about the behavior of the user, whether or not a first condition indicating a predictor of the user leaving the restaurant is satisfied; and determine, in a case where the first condition is satisfied, that a vehicle dispatch request for requesting dispatch of a vehicle to the restaurant is to be made, the vehicle being for movement of the user.

### CROSS REFERENCE TO THE RELATED APPLICATION

This application claims the benefit of Japanese Patent Application No. 2020-170241, filed on Oct. 8, 2020, which is hereby incorporated by reference herein in its entirety.

### BACKGROUND

### Technical Field

The present disclosure relates to an information processing apparatus, an information processing method, and a recording medium recorded with a program.

### Description of the Related Art

There is disclosed a vehicle dispatch system that controls a vehicle such that the vehicle arrives at a vehicle dispatch location for a user at an arrival time that is predicted from behavior of the user (for example, Japanese Patent Laid-Open No. 2019-101464).

An aspect of the disclosure is aimed at providing an information processing apparatus, an information processing method, and a recording medium recorded with a program that are capable of increasing convenience of a vehicle dispatch service.

### SUMMARY

An aspect of the present disclosure is an information processing apparatus comprising a processor configured to:
acquire information about behavior of a user visiting a restaurant;
determine, based on the information about the behavior of the user, whether or not a first condition indicating a predictor of the user leaving the restaurant is satisfied; and
determine, in a case where the first condition is satisfied, that a vehicle dispatch request for requesting dispatch of a vehicle to the restaurant is to be made, the vehicle being for movement of the user.

Another aspect of the present disclosure is an information processing method comprising:
by an information processing apparatus,
   acquiring information about behavior of a user visiting a restaurant;
   determining, based on the information about the behavior of the user, whether or not a first condition indicating a predictor of the user leaving the restaurant is satisfied; and
   determining, in a case where the first condition is satisfied, that a vehicle dispatch request for requesting dispatch of a vehicle to the restaurant is to be made, the vehicle being for movement of the user.

Another aspect of the present disclosure is a non-transitory computer-readable medium recorded with a program for causing a computer to:
acquire information about behavior of a user visiting a restaurant;
determine, based on the information about the behavior of the user, whether or not a first condition indicating a predictor of the user leaving the restaurant is satisfied; and
determine, in a case where the first condition is satisfied, that a vehicle dispatch request for requesting dispatch of a vehicle to the restaurant is to be made, the vehicle being for movement of the user.

According to the present disclosure, convenience of a vehicle dispatch service may be increased.

### BRIEF DESCRIPTION OF THE DRAWINGS

FIG. 1 is a diagram illustrating an example configuration of a vehicle dispatch system according to a first embodiment;

FIG. 2 is a diagram illustrating an example of a hardware configuration of the user terminal according to the first embodiment;

FIG. 3 is a diagram illustrating an example of a hardware configuration of the center server according to the first embodiment;

FIG. 4 is a diagram illustrating an example of functional configurations of the center server and the user terminal according to the first embodiment;

FIG. 5 is an example of a flowchart of a vehicle dispatch requesting process by the user terminal according to the first embodiment;

FIG. 6 is a diagram illustrating an example of a system configuration of a vehicle dispatch system according to a second embodiment; and

FIG. 7 is a diagram illustrating an example of a functional configuration of the store server.

### DESCRIPTION OF THE EMBODIMENTS

An aspect of the present disclosure is an information processing apparatus including a processor configured to acquire information about behavior of a user visiting a restaurant, determine, based on the information about the behavior of the user, whether or not a first condition indicating a predictor of the user leaving the restaurant is satisfied, and determine, in a case where the first condition is satisfied, that a vehicle dispatch request for requesting dispatch of a vehicle to the restaurant is to be made, the vehicle being for movement of the user.

The information processing apparatus may be a server installed in a restaurant, a server in a system coordinating with a restaurant, or a user terminal, for example. The first condition may be that a time that is a predetermined period of time before an expected start time of a next plan of the user is reached, that a sound including a predetermined keyword or a predetermined pattern indicating end of a meal is detected in a periphery of the user, that payment is made in relation to the user, or that the user is detected to be leaving for restroom, for example. However, the first condition is not limited to those listed above.

The processor may acquire information associated with the first condition, as the information about the behavior of the user. For example, in the case where the first condition is that a time that is a predetermined period of time before an expected start time of a next plan of the user is reached, the processor acquires schedule information of the user as the information about the behavior of the user. For example, in the case where the first condition is that a sound including a predetermined keyword or a predetermined pattern indicating end of a meal is detected in a periphery of the user, the processor acquires sound in the periphery of the user from a predetermined sound collecting device, analyzes the sound, and acquires an analysis result of the sound as the information about the behavior of the user. For example, in the case where the first condition is that payment is made by the user, the processor acquires information indicating that the payment is made for the user as the information about the behavior of the user. For example, in the case where the first condition is that the user is detected to be leaving for restroom, the processor acquires position information of the information processing apparatus as the information about the behavior of the user.

According to an aspect of the present disclosure, when the predictor of the user leaving the restaurant is detected from the information about the behavior of the user visiting the restaurant, the vehicle dispatch request is made in relation to the restaurant. A vehicle for movement of the user may thus be dispatched to the restaurant at a timing of the user leaving the restaurant, and convenience of a vehicle dispatch service is increased.

According to an aspect of the present disclosure, the processor may further be configured to determine whether or not a second condition is satisfied, and may make the vehicle dispatch request in a case where the first condition and the second condition are satisfied. For example, the second condition is that a rainfall state exists or that at least a predetermined number of drinks containing alcohol are included in an order list of the user. This allows dispatch to be performed in limited cases such that a vehicle is dispatched when dispatch of a vehicle is highly likely desired by the user, and a rate of use of a dispatched vehicle may be increased.

In the following, an embodiment of the present disclosure will be described with reference to the drawings. The configuration of the embodiment described below is an example, and the present disclosure is not limited to the configuration of the embodiment.

### First Embodiment

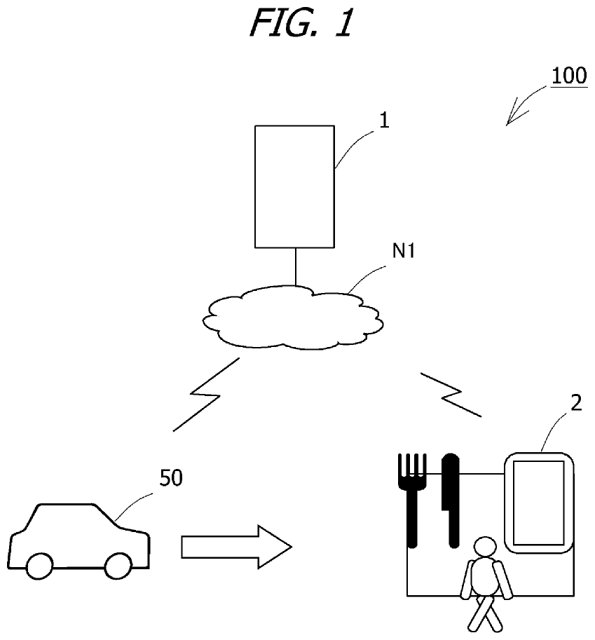

FIG. 1 is a diagram illustrating an example configuration of a vehicle dispatch system 100 according to a first embodiment. The vehicle dispatch system 100 includes a center server 1, a user terminal 2, and a vehicle 50. The vehicle dispatch system 100 is a system that provides a vehicle dispatch service of dispatching the vehicle 50 to a user leaving a restaurant.

The center server 1 receives a vehicle dispatch request from the user terminal 2, and dispatches the vehicle 50 to a specified restaurant. The vehicle 50 is a vehicle that is registered with the vehicle dispatch system 100. The vehicle dispatch system 100 may include a plurality of vehicles 50. However, FIG. 1 illustrates one vehicle 50 for the sake of simplicity.

The vehicle 50 is a vehicle that travels by being manually driven by a driver, or a vehicle that is capable of autonomous traveling without being operated by a driver, for example. In a case where the vehicle 50 is a vehicle that travels by being manually driven, the vehicle 50 includes an on-board unit including a communication function, and is capable of issuing instructions to the driver through the on-board unit, for example. In a case where the vehicle 50 is a vehicle that is capable of autonomous traveling, the vehicle 50 is provided with a control device, and the vehicle 50 may be controlled through instructions to the control device. In the following, communication related to the vehicle 50 is performed via a device that is mounted on the vehicle 50 and that includes the communication function, but a description will be given for the sake of convenience taking the vehicle 50 as a main entity in a manner such as “transmit an instruction to the vehicle 50”.

The center server 1, the user terminal 2, and the vehicle 50 are connected to a network N1. For example, the network N1 is the Internet. However, the network N1 is not limited to the Internet.

In the first embodiment, when detecting entrance into a restaurant, the user terminal 2 starts to monitor whether or not an exit predictor condition indicating a predictor of a user of the user terminal 2 leaving the restaurant is satisfied. Entrance into a restaurant is detected based on position information of the user terminal 2, or detection of a predetermined keyword indicating entrance, such as “Thank you for coming in”, from a sound, for example.

The exit predictor condition is that a time that is a predetermined period of time before an expected start time of a next plan is reached, that a sound including a predetermined keyword indicating end of a meal, such as “That was a wonderful meal!”, or a predetermined pattern, such as hand-clapping for celebrating conclusion, is detected from sound, that the user is detected to be left for restroom, or that payment is made, for example.

In the first embodiment, the user terminal 2 further determines whether or not an execution condition indicating that a vehicle dispatch request is to be made is satisfied. For example, the execution condition is that there is a consent of the user, that a rainfall state exists, or that at least a predetermined number of drinks containing alcohol are included in an order list. In the first embodiment, the user terminal 2 transmits the vehicle dispatch request to the center server 1 in a case where the exit predictor condition and the execution condition are satisfied. The exit predictor condition is an example of “first condition”. The execution condition is an example of “second condition”.

When the vehicle dispatch request is received from the user terminal 2, the center server 1 causes a vehicle 50 in a wait state to move to a specified restaurant. Accordingly, when the user of the user terminal 2 leaves the restaurant, the vehicle 50 is already present or will arrive shortly, and the user may move to a predetermined destination using the vehicle 50. Accordingly, convenience of the vehicle dispatch service provided by the vehicle dispatch system 100 is increased.

In the first embodiment, the vehicle dispatch request is made in a case where the exit predictor condition and the execution condition are satisfied, but such a case is not restrictive, and the vehicle dispatch request may alternatively be made in a case where the exit predictor condition is satisfied.

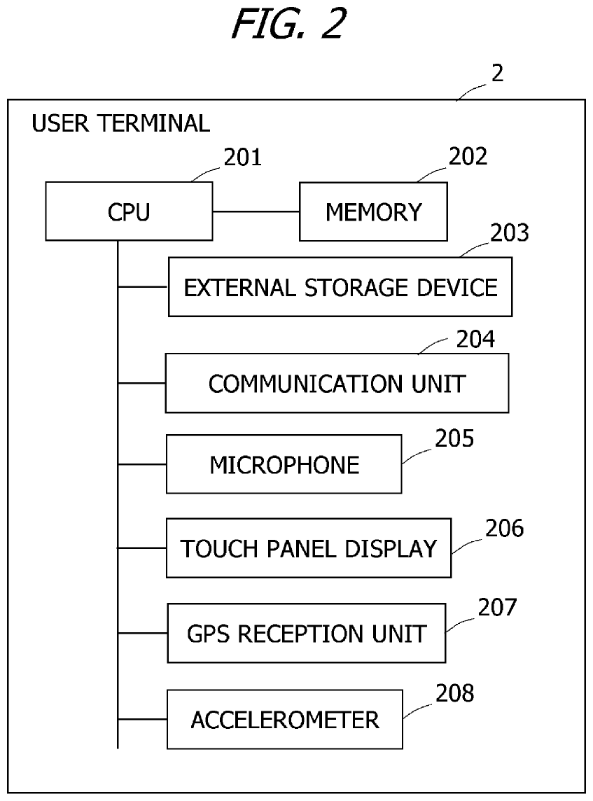

FIG. 2 is a diagram illustrating an example of a hardware configuration of the user terminal 2 according to the first embodiment. For example, the user terminal 2 is a terminal that is carried by the user, such as a smartphone, a tablet terminal, or a wearable terminal. As hardware components, the user terminal 2 includes a central processing unit (CPU) 201, a memory 202, an external storage device 203, a communication unit 204, a microphone 205, a touch panel display 206, a global positioning system (GPS) reception unit 207, and an accelerometer 208. The memory 202 and the external storage device 203 are each a computer-readable recording medium. In FIG. 2, hardware components related to the vehicle dispatch system 100, among the hardware components of the user terminal 2, are extracted and illustrated. The hardware components provided in the user terminal 2 are not limited to those illustrated in FIG. 2. The user terminal 2 is an example of “information processing apparatus”.

The external storage device 203 stores various programs, and data that is used by the CPU 201 at the time of execution of each program. The external storage device 203 is an erasable programmable ROM (EPROM) and/or a hard disk drive, for example. Programs held in the external storage device 203 include an operating system (OS), a vehicle dispatch request control program of the vehicle dispatch system 100, and various other application programs, for example. The vehicle dispatch request control program of the vehicle dispatch system 100 is a program for controlling the vehicle dispatch request to the center server 1. The vehicle dispatch request control program of the vehicle dispatch system 100 is an application program, for example, and is downloaded from a download site for application programs on a web to be installed.

The memory 202 is a main memory that provides the CPU 201 with a storage area where programs that are stored in the external storage device 203 are loaded and a work area, and that is used as a buffer. For example, the memory 202 includes semiconductor memories such as a read only memory (ROM) and a random access memory (RAM).

The CPU 201 performs various processes by loading the OS and various application programs held in the external storage device 203 into the memory 202, and executing the same. There may be a plurality of CPUs 201, without being limited to one. The CPU 201 is an example of “processor”.

The communication unit 204 is an interface through which information is input/output from a network. For example, the communication unit 204 performs wireless communication by a mobile communication system such as long term evolution (LTE), LTE-Advanced, and 5th Generation (5G), or via WiFi or the like, and connects to a public network such as the Internet.

The microphone 205 is a sound collecting device. The microphone 205 converts a collected sound signal into sound data, and outputs the sound data to the CPU 201. On/off of the microphone 205 is controlled by the CPU 201.

The touch panel display 206 includes a liquid crystal panel and a touch panel, and functions as an output device and an input device. A user operation input from the touch panel display 206 is output to the CPU 201. Furthermore, the touch panel display 206 displays screen data that is input from the CPU 201.

The GPS reception unit 207 receives radio waves from GPS satellites, measures a current position based on the received radio waves, and acquires position information. The GPS reception unit 207 measures the current position every predetermined period of time. The position information that is acquired by the GPS reception unit 207 is latitude and longitude, for example. The position information that is acquired by the GPS reception unit 207 is output to the CPU 201.

The accelerometer 208 detects acceleration that is applied to the user terminal 2. For example, that the user is moving while carrying the user terminal 2 may be detected based on a detected value of acceleration from the accelerometer 208. The detected value from the accelerometer 208 is output to the CPU 201. Note that the hardware configuration of the user terminal 2 is not limited to the one illustrated in FIG. 2.

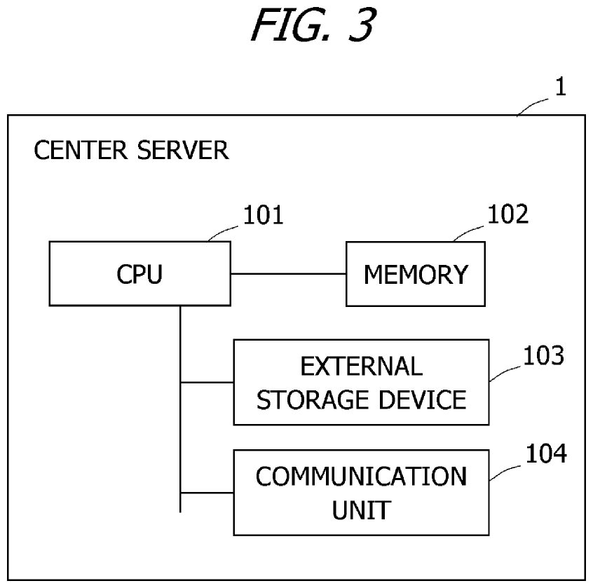

FIG. 3 is a diagram illustrating an example of a hardware configuration of the center server 1 according to the first embodiment. As hardware components, the center server 1 includes a CPU 101, a memory 102, an external storage device 103, and a communication unit 104. The memory 102 and the external storage device 103 are each a computer-readable recording medium. The center server 1 is an example of “information processing apparatus”.

The CPU 101, the memory 102, and the external storage device 103 are the same as the CPU 201, the memory 202, and the external storage device 203, respectively. The external storage device 203 holds a control program of the vehicle dispatch system 100. The control program of the vehicle dispatch system 100 is a program for dispatching the vehicle 50 to a specified location in a case where the vehicle dispatch request is received.

The communication unit 104 is an interface to the network N1. For example, the communication unit 104 is a network interface card (NIC) for connecting to a local area network (LAN). The communication unit 104 converts an electric signal input from the network N1 into data in a predetermined format, and outputs obtained data to the CPU 101, and also converts data input from the CPU 101 into an electric signal and outputs the same to the network N1. Note that the hardware configuration of the center server 1 is not limited to the one illustrated in FIG. 3.

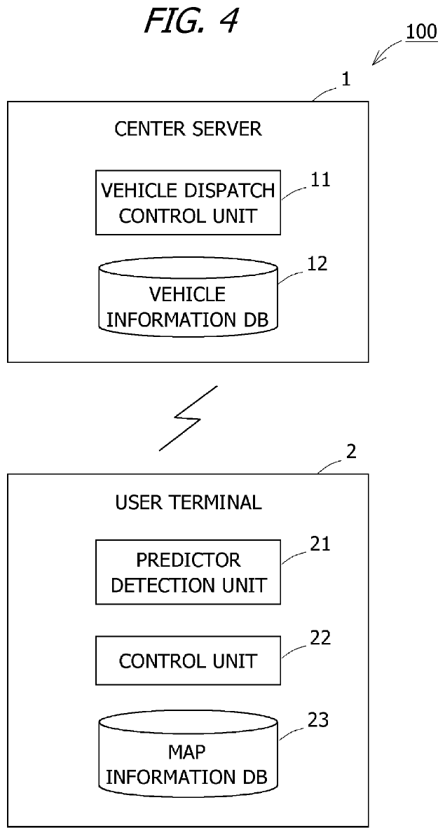

FIG. 4 is a diagram illustrating an example of functional configurations of the center server 1 and the user terminal 2 according to the first embodiment. As functional components, the center server 1 includes a vehicle dispatch control unit 11, and a vehicle information database (DB) 12. The vehicle dispatch control unit 11 and the vehicle information DB 12 are implemented by the CPU 101 executing predetermined programs.

The vehicle dispatch control unit 11 receives the vehicle dispatch request from the user terminal 2. Information about a restaurant as a movement destination of the vehicle 50 is also received together with the vehicle dispatch request. The information about a restaurant includes a name, an address and the like of the restaurant, for example. When the vehicle dispatch request is received, the vehicle dispatch control unit 11 refers to the vehicle information DB 12 described later, and determines the vehicle 50 to be dispatched. The vehicle 50 to be dispatched is selected from the vehicles 50 that are in a wait state, for example. Alternatively, the vehicle 50 to be dispatched may be selected from vehicles that are present in a predetermined range of the restaurant as the movement destination. The method of selecting the vehicle 50 to be dispatched is not limited to a specific method. The vehicle dispatch control unit 11 transmits, to the vehicle 50 that is determined, a movement command to move to the specified restaurant.

The vehicle information DB 12 is created in a storage area of the external storage device 103. The vehicle information DB 12 holds information about the vehicle 50. The information about the vehicle 50 that is held in the vehicle information DB 12 includes identification information, position information, and a state of the vehicle 50, for example. The state of the vehicle 50 indicates that the vehicle 50 is in operation for the vehicle dispatch service or is in standby, for example. The position information of the vehicle 50 is transmitted from the vehicle 50 to the center server 1 every predetermined period of time, and is updated by the vehicle dispatch control unit 11. Note that information to be held in the vehicle information DB 12 are not limited to those mentioned above.

Next, as functional components, the user terminal 2 includes a predictor detection unit 21, a control unit 22, and a map information DB 23. These functional components are implemented by the CPU 201 of the user terminal 2 executing predetermined programs, for example.

The control unit 22 controls the vehicle dispatch request. The control unit 22 detects entrance of the user of the user terminal 2 into a restaurant. Entrance of the user of the user terminal 2 into a restaurant serves as an activation condition for the predictor detection unit 21 described later. In the following, the activation condition for the predictor detection unit 21 will be referred to as a start condition.

For example, the start condition is defined as one or a combination of a plurality of the following: (1) the position information of the user terminal 2 indicates presence at a restaurant, (2) sound including a predetermined keyword indicating entrance, such as “Thank you for coming in”, is detected, and (3) guidance to a restaurant by a navigation application is ended. That (1) the position information of the user terminal 2 indicates presence at a restaurant is detected by the control unit 22 acquiring the position information of the user terminal 2 and referring to the map information DB 23, described later, in which the position information indicates a restaurant, for example. That (2) sound including a predetermined keyword is detected is detected by the control unit 22 analyzing sound data collected by the microphone 205 and detecting a keyword that is set in advance, for example. The predetermined keyword indicating entrance is “Thank you for coming in” “Enjoy!”, or “May I take your order?”, for example.

That (3) guidance to a restaurant by a navigation application is ended is detected by the control unit 22 monitoring the navigation application installed in the user terminal 2, for example. Note that the conditions for detecting entrance of the user of the user terminal 2 into a restaurant are not limited to (1) to (3) described above.

In a case where satisfaction of the start condition is detected, the control unit 22 activates the predictor detection unit 21. The predictor detection unit 21 described later detects a predictor of the user of the user terminal 2 leaving the restaurant. When the predictor of the user of the user terminal 2 leaving the restaurant is detected by the predictor detection unit 21, the control unit 22 determines whether or not the execution condition for making the vehicle dispatch request is satisfied.

The execution condition for making the vehicle dispatch request is one or a combination of a plurality of the following: (A) there is a consent of the user of the user terminal 2 for execution of the vehicle dispatch request, (B) the rainfall state currently exists, and (C) at least a predetermined number of drinks containing alcohol are included in the order list, for example. Note that the conditions for making the vehicle dispatch request are not limited to (A) to (C) described above.

That (A) there is a consent of the user of the user terminal 2 for execution of the vehicle dispatch request is detected based on input of a user operation indicating consent to a screen that is output on the touch panel display 206 by the control unit 22, the screen being for inquiring whether or not the vehicle dispatch request can be made, for example.

That (B) the rainfall state currently exists is detected by the control unit 22 acquiring information about the current rainfall state from the web, for example. In the case of rain, the demand for movement by a vehicle is increased, and thus, the demand for dispatch of the vehicle 50 is highly likely increased.

That (C) at least a predetermined number of drinks containing alcohol are included in the order list is detected by the control unit 22 acquiring, through the center server 1, the order list from a server managing the restaurant, for example. The control unit 22 transmits an acquisition request for the order list to the center server 1, and the center server 1 acquires the order list of the user of the user terminal 2 from the server managing the restaurant and transmits the same to the user terminal 2, for example. Some restaurants possibly do not include a server that manages the order list on a per-customer basis, and in such a case, a notification indicating that response is not possible is transmitted from the center server 1 to the user terminal 2. In the case where the user consumed a certain amount of alcohol, movement on foot or the like is possibly difficult, and the demand for movement by a vehicle is increased.

In the case where the execution condition is satisfied, the control unit 22 transmits the vehicle dispatch request to the center server 1. The control unit 22 also transmits information about the restaurant as the current position to the center server 1, together with the vehicle dispatch request.

The predictor detection unit 21 acquires information about behavior of the user, and detects whether or not the exit predictor condition is satisfied, or in other words, detects the predictor of the user of the user terminal 2 leaving the restaurant. When the exit predictor condition is satisfied, the predictor detection unit 21 notifies the control unit 22 of that. The exit predictor condition is one or a combination of a plurality of the following: (I) a time that is a predetermined period of time before an expected start time of a next plan is reached, (II) sound including a predetermined keyword or a predetermined pattern indicating end of a meal is detected, (III) payment is made, (IV) the user of the user terminal 2 is detected to be leaving for restroom, and (V) a predetermined food or drink is ordered.

That (I) a time that is a predetermined period of time before an expected start time of a next plan is reached is detected by the predictor detection unit 21 acquiring schedule information, as information about the behavior of the user, from a schedule management application installed in the user terminal 2. That (II) sound including a predetermined keyword or a predetermined pattern indicating end of a meal is detected is detected by the predictor detection unit 21 analyzing sound data collected by the microphone 205 and detecting a keyword that is set in advance or a predetermined pattern from the sound data, for example. The predetermined keyword indicating end of a meal is “That was a wonderful meal!”, “Check, please!”, or “Could I have some water, please?”, for example. The predetermined pattern is calls and handclaps for celebrating conclusion, or handclaps, for example.

That (III) payment is made is detected by detecting execution of a payment process by a payment application installed in the user terminal 2, for example. Note that the condition of (III) is not used in a case where payment is made in cash or by a method that is not detected by an application installed in the user terminal 2.

For example, (IV) the user of the user terminal 2 leaving for the restroom is detected by the predictor detection unit 21 detecting application of a predetermined amount of acceleration to the user terminal 2 based on a detected value from the accelerometer 208, for example. Furthermore, the user of the user terminal 2 leaving for the restroom may also be detected based on the position information of the user terminal 2, for example. This is because, in many cases, one uses the restroom at the end of a dinner meeting or a party.

That (V) a predetermined food or drink is ordered is detected by the predictor detection unit 21 acquiring the order list, through the center server 1, from a server managing the restaurant, for example. A predetermined food or drink that indicates end of a meal is a dessert, and a drink that is ordered together with a dessert, such as coffee or tea, for example. Note that the exit predictor condition is not limited to (I) to (V) described above.

### Flow of Processes

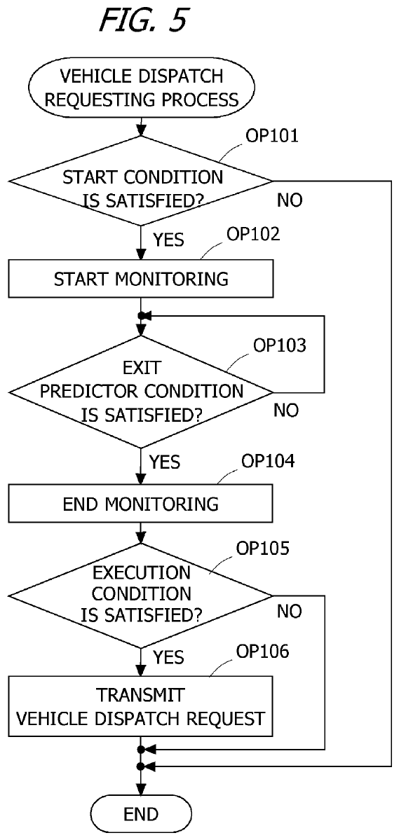

FIG. 5 is an example of a flowchart of a vehicle dispatch requesting process by the user terminal 2 according to the first embodiment. The process illustrated in FIG. 5 is repeated every predetermined period of time. The main performer of the process illustrated in FIG. 5 is the CPU 201 of the user terminal 2, but a description will be given taking a functional component as the main performer for the sake of convenience.

In OP101, the control unit 22 determines whether or not the start condition is satisfied. For example, at least one of (1) to (3) described above is set as the start condition. In the case where more than one of (1) to (3) described above are set as the start conditions, a positive determination is made in OP101 when one or all of the set conditions are satisfied. In the case where the start condition is satisfied (OP101: YES), the process proceeds to OP102. In the case where the start condition is not satisfied (OP101: NO), the process illustrated in FIG. 5 is ended.

In OP102, the control unit 22 activates the predictor detection unit 21, and starts to perform monitoring regarding the predictor of the user of the user terminal 2 leaving the restaurant.

In OP103, the control unit 22 determines whether or not satisfaction of the exit predictor condition is detected by the predictor detection unit 21. At least one of (I) to (V) described above is set as the exit predictor condition, for example. In the case where more than one of (I) to (V) described above are set as the exit predictor conditions, a positive determination is made in OP103 when one or all of the set conditions are satisfied. In the case where the exit predictor condition is satisfied (OP103: YES), the process proceeds to OP104. In the case where the exit predictor condition is not satisfied (OP103: NO), the process in OP103 is repeated.

In OP104, because satisfaction of the exit predictor condition is detected, the control unit 22 stops the predictor detection unit 21, and ends the monitoring regarding the predictor of the user of the user terminal 2 leaving the restaurant.

In OP105, the control unit 22 determines whether or not the execution condition is satisfied. At least one of (A) to (C) described above is set as the execution condition, for example. In the case where more than one of (A) to (C) described above are set as the execution conditions, a positive determination is made in OP105 when one or all of the set conditions are satisfied. In the case where the execution condition is satisfied (OP105: YES), the process proceeds to OP106. In OP106, the control unit 22 transmits the vehicle dispatch request to the center server 1. In the case where the execution condition is not satisfied (OP105: NO), the process illustrated in FIG. 5 is ended.

Note that the vehicle dispatch requesting process by the user terminal 2 is not limited to the process illustrated in FIG. 5. For example, the vehicle dispatch request may be made when the exit predictor condition is satisfied, and in this case, the process in OP105 is omitted.

### Operations and Effects of First Embodiment

In the first embodiment, the vehicle dispatch request is made when the predictor of the user leaving the restaurant is detected, and thus, the vehicle 50 may be dispatched to the restaurant at a timing of the user leaving the restaurant. Accordingly, for example, the time the user, who wants to move by a vehicle, spends waiting for arrival of the vehicle may be reduced, and convenience of the vehicle dispatch service is increased.

In the first embodiment, the vehicle dispatch request is made in the case where the execution condition is satisfied, or in other words, in the case where the demand for vehicle dispatch is likely increased. This increases the probability of the vehicle 50 dispatched to the restaurant being actually used, and the rate of use of the vehicle 50 may be increased.

In the first embodiment, vehicle dispatch control is performed by the user terminal 2, and thus, the restaurant does not have to prepare special equipment, and introduction is facilitated, for example.

### Second Embodiment

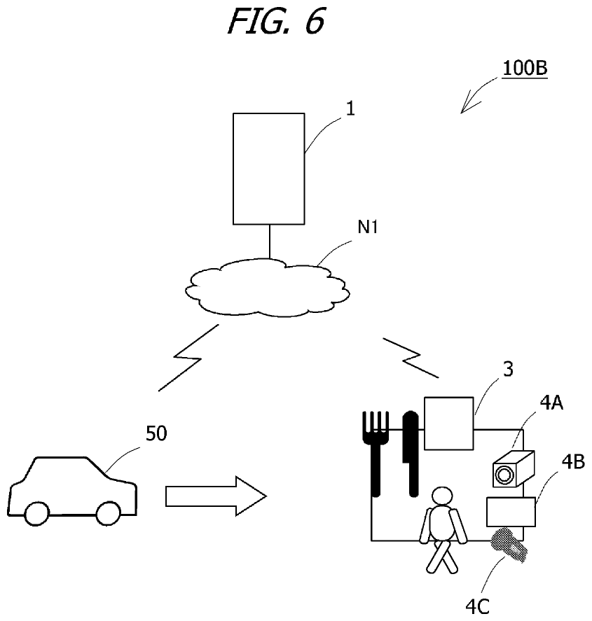

FIG. 6 is a diagram illustrating an example of a system configuration of a vehicle dispatch system 100B according to a second embodiment. The vehicle dispatch system 100B according to the second embodiment includes the center server 1, the vehicle 50, a store server 3, and various sensors 4.

In the second embodiment, control regarding the vehicle dispatch request is performed by the store server 3. The store server 3 is a server that is installed in a restaurant coordinating with the vehicle dispatch system 100B. In the second embodiment, the store server 3 determines, based on information from the various sensors 4 installed in the restaurant, whether or not the exit predictor condition is satisfied and whether or not the execution condition is satisfied, and transmits the vehicle dispatch request to the center server 1 in a case where the exit predictor condition and the execution condition are satisfied.

For example, the various sensors 4 are a camera 4A, a self-ordering terminal 4B, and a microphone 4C. Note that the sensors to be installed in a restaurant are not limited to those mentioned above. In the case of not distinguishing among those mentioned above, the term “sensor(s) 4” will be simply used. Each sensor 4 is connected to the store server 3 through a LAN, for example.

There are provided a plurality of cameras 4A, a plurality of self-ordering terminals 4B, and a plurality of microphones 4C. For example, the camera 4A, the self-ordering terminal 4B, and the microphone 4C are disposed at each table. The self-ordering terminal 4B is a terminal that is operated by a customer to make an order. The order list ordered through the self-ordering terminal 4B is transmitted to the store server 3 and is recorded. Images and sound data acquired by the camera 4A and the microphone 4C are transmitted to the store server 3.

As hardware components, the store server 3 includes a CPU, a memory, an external storage device, and a communication unit, for example. The CPU, the memory, the external storage device, and the communication unit of the store server 3 are the same as the CPU 101, the memory 102, the external storage device 103, and the communication unit 104 of the center server 1. The external storage device holds a vehicle dispatch request control program of the vehicle dispatch system 100B. The vehicle dispatch request control program is a program for making the vehicle dispatch request to the center server 1.

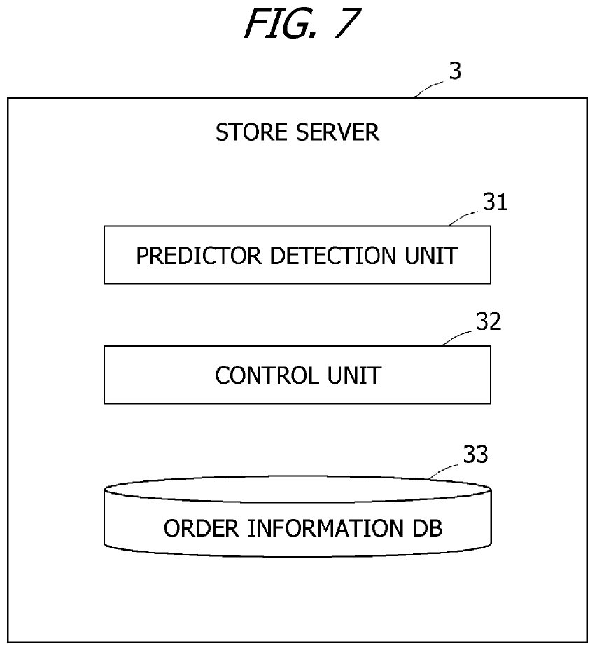

FIG. 7 is a diagram illustrating an example of a functional configuration of the store server 3. As functional components, the store server 3 includes a predictor detection unit 31, a control unit 32, and an order information DB 33. These functional components are implemented by the CPU of the store server 3 executing predetermined programs.

The predictor detection unit 31 and the control unit 32 implement the same functions as the predictor detection unit 21 and the control unit 22. However, the predictor detection unit 31 and the control unit 32 differ from the predictor detection unit 21 and the control unit 22 in some respects regarding the determination methods for the start condition, the exit predictor condition, and the execution condition.

In the second embodiment, the start conditions are that (1-1) an order is placed through the self-ordering terminal 4B and that (2-1) seating of the user is detected from a captured image from the camera 4A, for example. Note that the start conditions in the second embodiment are not limited to those mentioned above.

That (1-1) an order is placed through the self-ordering terminal 4B is detected by the control unit 32 receiving an order request from the self-ordering terminal 4B, for example. The order list is also received together with the order request, and is recorded in the order information DB 33, described later, by the control unit 32.

That (2-1) seating of the user is detected from a captured image from the camera 4A is detected by the control unit 32 performing an image analysis process on the captured image from the camera 4A, for example.

In the second embodiment, the exit predictor condition is one or a combination of a plurality of the following: (II) sound including a predetermined keyword or a predetermined pattern indicating end of a meal is detected, (III) payment is made, (IV) the user of the user terminal 2 is detected to be leaving for restroom, and (V) a predetermined food or drink is ordered. The schedule information of the user is personal information and is difficult for the store server 3 to acquire, and thus, in the second embodiment, the exit predictor condition does not include (I) a time that is a predetermined period of time before an expected start time of a next plan is reached.

That (II) sound including a predetermined keyword or a predetermined pattern indicating end of a meal is detected is detected by the predictor detection unit 31 analyzing sound data collected by the microphone 4C and detecting a keyword that is set in advance or a predetermined pattern from the sound data, for example.

That (III) payment is made is detected by the predictor detection unit 31 detecting reception of a settlement request from the self-ordering terminal 4B, for example. When an operation such as pressing of a settlement button is performed by the user on the self-ordering terminal 4B, the settlement request is transmitted from the self-ordering terminal 4B to the store server 3. Alternatively, that payment is made may be detected by using information related to a cash register installed in the store server 3.

For example, (IV) the user of the user terminal 2 leaving for the restroom is detected by the predictor detection unit 31 performing an image analysis process on a captured image from the camera 4A. That (V) a predetermined food or drink indicating end of a meal is ordered is detected by the predictor detection unit 31 detecting reception of an order request for the predetermined food or drink from the self-ordering terminal 4B, for example.

In the second embodiment, as in the first embodiment, the execution condition for making the vehicle dispatch request is, for example, one or a combination of a plurality of the following: (A) there is a consent of the user of the user terminal 2 for execution of the vehicle dispatch request, (B) the rainfall state currently exists, and (C) at least a predetermined number of drinks containing alcohol are included in the order list.

That (A) there is a consent of the user of the user terminal 2 for execution of the vehicle dispatch request is detected based on input of a user operation indicating consent to a screen that is output by the control unit 32 on a display of the self-ordering terminal 4B corresponding to a table for which satisfaction of the exit predictor condition is detected, the screen being for inquiring whether or not the vehicle dispatch request can be made, for example.

That (B) the rainfall state currently exists is detected by the control unit 32 acquiring information about the current rainfall state from the web, for example. That (C) at least a predetermined number of drinks containing alcohol are included in the order list is detected by the control unit 32 acquiring, from the order information DB 33 described later, the order list for the table for which satisfaction of the exit predictor condition is detected, for example.

The order information DB 33 is created in a storage area of the external storage device of the store server 3. Order information is stored in the order information DB 33. The order information includes identification information of the table, customer identification information, date/time of order, and the order list, for example. The customer identification information is information for identifying a group of customers at each table, and is assigned to each customer group by a predetermined method.

A flowchart of the vehicle dispatch requesting process by the store server 3 in the second embodiment is the same as the one illustrated in FIG. 5. However, in the second embodiment, the process in FIG. 5 is performed for each customer group. That is, the control unit 32 determines, for one customer group, whether or not the start condition is satisfied, and in the case where the start condition is satisfied, the control unit 32 causes the predictor detection unit 31 to start determination of whether or not the exit predictor condition is satisfied, and transmits the vehicle dispatch request to the center server 1 in a case where the exit predictor condition is satisfied and the execution condition is satisfied. Also in the second embodiment, the control unit 32 may alternatively transmit the vehicle dispatch request to the center server 1 when the exit predictor condition is satisfied.

In the second embodiment, the store server 3 controls the vehicle dispatch request. Accordingly, the vehicle dispatch service may be provided even when the user visiting a store does not perform setting nor have equipment, for example. In the second embodiment, the store server 3 is provided at the restaurant, and the store server 3 controls the vehicle dispatch request, but the function may alternatively be partially or wholly implemented by the center server 1.

### Other Embodiments

The embodiment described above is an example, and the present disclosure may be changed and carried out as appropriate without departing from the gist of the present disclosure.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to:
acquire information about behavior of a user visiting a restaurant;
determine, based on the information about the behavior of the user, whether or not a first condition indicating a predictor of the user leaving the restaurant is satisfied; and
determine, in a case where the first condition is satisfied, that a vehicle dispatch request for requesting dispatch of a vehicle to the restaurant is to be made, the vehicle being for movement of the user.

2. The information processing apparatus according to claim 1, wherein
the information processing apparatus is a user terminal carried by the user,
the first condition is that a time that is a predetermined period of time before an expected start time of a next plan of the user is reached, and
the processor is configured to acquire schedule information of the user as the information about the behavior of the user.

3. The information processing apparatus according to claim 1, wherein
the first condition is that a sound including a predetermined keyword or a predetermined pattern indicating end of a meal is detected in a periphery of the user, and
the processor is configured to acquire the sound in the periphery of the user from a predetermined sound collecting device, analyze the sound, and acquire an analysis result of the sound as the information about the behavior of the user.

4. The information processing apparatus according to claim 1, wherein
the first condition is that payment is made in relation to the user, and
the processor is configured to acquire information indicating that the payment is made as the information about the behavior of the user.

5. The information processing apparatus according to claim 1, wherein the first condition is that the user is detected to be leaving for restroom.

6. The information processing apparatus according to claim 1, wherein the processor is configured to:
determine whether or not a second condition is satisfied, and
make the vehicle dispatch request in a case where the first condition and the second condition are satisfied.

7. The information processing apparatus according to claim 6, wherein
the second condition is that a rainfall state exists, and
the processor is configured to acquire information about the rainfall state over a network, and determine whether or not the second condition is satisfied based on the information about the rainfall state.

8. The information processing apparatus according to claim 6, wherein
the second condition is that at least a predetermined number of drinks containing alcohol are included in an order list of the user, and
the processor is configured to acquire information about the order list of the user, and determine whether or not the second condition is satisfied based on the information about the order list of the user.

9. The information processing apparatus according to claim 1, wherein the processor is further configured to start determination of whether or not the first condition is satisfied, in a case where entrance of the user into the restaurant is detected.

10. The information processing apparatus according to claim 9, wherein
the information processing apparatus is a user terminal carried by the user, and
the processor is configured to:
acquire position information of the information processing apparatus, and
detect entrance of the user into the restaurant based on the position information.

11. The information processing apparatus according to claim 9, wherein
the information processing apparatus
is a user terminal carried by the user, and
includes a microphone, and
the processor is configured to analyze sound data collected by the microphone, and detect entrance of the user into the restaurant in a case where a predetermined keyword indicating entrance is detected from the sound data.

12. An information processing method comprising:
by an information processing apparatus,
acquiring information about behavior of a user visiting a restaurant;
determining, based on the information about the behavior of the user, whether or not a first condition indicating a predictor of the user leaving the restaurant is satisfied; and
determining, in a case where the first condition is satisfied, that a vehicle dispatch request for requesting dispatch of a vehicle to the restaurant is to be made, the vehicle being for movement of the user.

13. The information processing method according to claim 12, wherein
the information processing apparatus is a user terminal carried by the user,
the first condition is that a time that is a predetermined period of time before an expected start time of a next plan of the user is reached, and
the information processing method includes acquiring schedule information of the user as the information about the behavior of the user.

14. The information processing method according to claim 12, wherein
the first condition is that a sound including a predetermined keyword or a predetermined pattern indicating end of a meal is detected in a periphery of the user, and
the information processing method includes acquiring the sound in the periphery of the user from a predetermined sound collecting device, analyzing the sound, and acquiring an analysis result of the sound as the information about the behavior of the user.

15. The information processing method according to claim 12, wherein
the first condition is that payment is made in relation to the user, and
the information processing method includes acquiring information indicating that the payment is made as the information about the behavior of the user.

16. The information processing method according to claim 12, wherein the first condition is that the user is detected to be leaving for restroom.

17. The information processing method according to claim 12, including determining whether or not a second condition is satisfied, and
making the vehicle dispatch request in a case where the first condition and the second condition are satisfied.

18. The information processing method according to claim 17, wherein
the second condition is that a rainfall state exists, and
the information processing method includes acquiring information about the rainfall state over a network, and determining whether or not the second condition is satisfied based on the information about the rainfall state.

19. The information processing method according to claim 17, wherein
the second condition is that at least a predetermined number of drinks containing alcohol are included in an order list of the user, and
the information processing method includes acquiring information about the order list of the user, and determining whether or not the second condition is satisfied based on the information about the order list of the user.

20. A non-transitory computer-readable medium recorded with a program for causing a computer to:
acquire information about behavior of a user visiting a restaurant;
determine, based on the information about the behavior of the user, whether or not a first condition indicating a predictor of the user leaving the restaurant is satisfied; and
determine, in a case where the first condition is satisfied, that a vehicle dispatch request for requesting dispatch of a vehicle to the restaurant is to be made, the vehicle being for movement of the user.
